(19) United States
(12) Patent Application Publication
(10) Pub. No.: US 2026/0297977 A1
(43) Pub. Date: Oct. 1, 2026

(54) FENCE/ RAILING STRUCTURE

(71) Applicant: Chingyao KUO, New Taipei City (TW)

(72) Inventor: Chingyao KUO, New Taipei City (TW)

(21) Appl. No.: 19/276,543

(22) Filed: Jul. 22, 2025

(30) Foreign Application Priority Data
Apr. 1, 2025 (TW) 114203239

(51) Int. Cl. E04H 17/14; E04H 17/22; F21S 9/03; F21V 33/00; G01J 5/00; G08B 13/191; H02S 20/20

(52) U.S. Cl. CPC E04H 17/1426; E04H 17/22; F21S 9/035; F21V 33/006; G01J 5/0025; G08B 13/191; H02S 20/20

(57) ABSTRACT

An improvement of fence/railing structure comprising components formed from composite materials composed of aluminum alloy or high-strength fibers combined with weather-resistant resin. These components are connected using quick-assembly methods such as snap-fit and mortise-and-tenon joints, allowing for easy disassembly and reassembly. The fence/railing can be equipped with a human detection sensor, a weather sensor, a LED light strip, and a buzzer. This configuration enables the fence/railing to function effectively in various weather conditions or harsh environments. When intruders are detected or severe weather is sensed, the system emits flashing lights and audible alarms to provide comprehensive safety protection.

### BACKGROUND OF THE INVENTION

### Field of the Invention

The present invention relates to a fence/railing structure, particularly to a fence/railing structure equipped with a human detection sensor, a whether sensor, a LED light strip, and a buzzer. When an intruder is detected or adverse weather is sensed, an audible alarm is triggered to provide comprehensive safety protection.

### Description of the Prior Art

Fences, or railings, became part of our daily lives a long time ago. Living rooms and dining rooms are divided when railings are set up in the house. Railings can also be helpful to the old or the sick, so that they are able to move around. They can also be used to protect babies or young children. Railings are mostly used outside of the house in hallways. As for fences, they are used to create borders. When fences are near to the house, they circle around a yard. When they are farther away from the house, they are used to show where the larger borders are. In addition, they can also prevent captured or domesticated animals from escape or avoid attacks/intrusions from strangers/wild animals. Nowadays, railings/fences are also commonly used in construction, transportation, public facilities, and other areas for safety protection or area demarcation.

Conventional fences/railings serve only a partitioning function and lack capabilities such as emitting flashing lights or alarm sounds in the event of intrusion or weather changes to alert residents.

Accordingly, the present invention has been invented to solve the above-mentioned problems occurred in the prior art.

### SUMMARY OF THE INVENTION

Accordingly, the present invention provides an improvement of fence/railing structure, composed of components made from composite materials of aluminum alloy or high-strength fiber and weather-resistant resin. These components are connected via snap-fit, mortise-and-tenon, or similar mechanisms, allowing for quick assembly and disassembly.

The second object of the present invention is to provide an improvement of fence/railing structure, which the use of such composite materials enables the fence to be installed in environments with severe weather fluctuations. These materials offer long service life and ease of maintenance, which is a secondary objective of the present invention.

The third object of the present invention is to provide an improvement of fence/railing structure, which the fence/railing is equipped with a human detection sensor, a weather sensor, a LED light strip, a buzzers, and a communication module. When an intruder is detected or adverse weather is sensed, the system emits flashes or audible alerts to ensure comprehensive safety protection.

The forth object of the present invention is to provide an improvement of fence/railing structure, which the fence/railing may also include solar panels and solar batteries, enabling the sensors, LED lights, buzzers, and communication modules to operate independently of the main power grid.

The fifth object of the present invention is to provide an improvement of fence/railing structure, which the components include posts, horizontal beams, railings, and ground stakes. The surface of the ground stake is threaded for easy insertion into the ground. Inside, the ground stake includes a channel with multiple perforations along its wall. A soil hardening agent can be filled inside the channel. Upon water injection, the hardening agent seeps through the perforations into the soil, ensuring a stable bond between the stake and the surrounding earth, thus forming a solid foundation.

The above purposes and structure of the present invention will be more apparent from the following detailed description taken in conjunction with the accompanying drawings:

### BRIEF DESCRIPTION OF THE DRAWINGS

FIG. 1 is a perspective view showing the assembled structure of the improvement of fence/railing structure of the present invention.

FIG. 2 is an exploded perspective view of the improvement of fence/railing structure of the present invention.

FIG. 3 is an enlarged view of portion A in FIG. 2.

FIG. 4 is an enlarged view of portion B in FIG. 3.

FIG. 5 is an enlarged view of portion C in FIG. 2.

FIG. 6 is a sectional view of the ground stake according to the improvement of fence/railing structure of the present invention.

FIG. 7 is a perspective view showing a second embodiment of the improvement of fence/railing structure of the present invention.

FIG. 8 is a perspective view showing a third embodiment of the improvement of fence/railing structure of the present invention.

FIG. 9 is an exploded perspective view of the third embodiment of the improved fence of the present invention.

FIG. 10 is an enlarged view of the weather sensor of the improvement of fence/railing structure of the present invention.

FIG. 11 is a perspective view showing a fourth embodiment of the improvement of fence/railing structure of the present invention.

FIG. 12A is an enlarged view of a base plate installed on a post in the fourth embodiment of the improvement of fence/railing structure of the present invention.

FIG. 12B is an enlarged view of a connecting member installed on the upper horizontal beam in the fourth embodiment of the improvement of fence/railing structure of the present invention.

FIG. 12C is an enlarged view showing a drink rail panel mounted on the upper horizontal beam in the fourth embodiment of the improvement of fence/railing structure of the present invention.

FIG. 13 is a perspective view showing a fifth embodiment of the improvement of fence/railing structure of the present invention.

FIG. 14 is an exploded perspective view of the fifth embodiment of the improvement of fence/railing structure of the present invention.

FIG. 15 is a sectional view of the upper and lower glass clamping sleeves in the fifth embodiment of the improvement of fence/railing structure of the present invention.

FIG. 16 is a partially enlarged sectional view showing the controller installation in the fifth embodiment of the improvement of fence/railing structure of the present invention.

### DETAILED DESCRIPTION OF PREFERRED EMBODIMENT

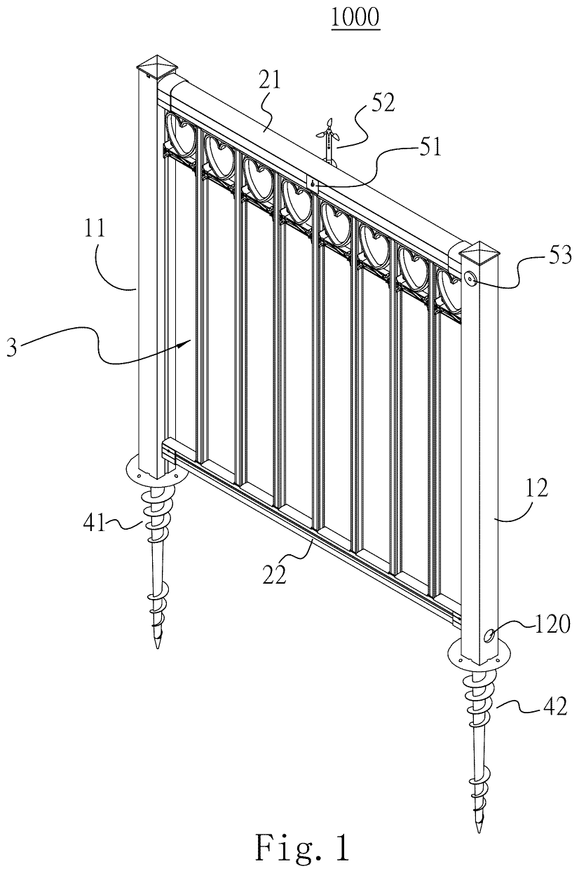

As shown in FIG. 1, the fence/railing structure 1000 comprises a set of posts 11, 12, an upper horizontal beam 21, a lower horizontal beam 22, a railing assembly 3, and a set of ground stakes 41, 42. A human detection sensor 51 is installed on the front side of the upper horizontal beam 21, capable of detecting nearby humans. A weather sensor 52 is installed on the top of the upper horizontal beam 21 to detect environmental wind speed and rainfall. A buzzer 53 capable of emitting alarm sounds is mounted on post 12. Thus, when the human detection sensor 51 detects an intruder or the weather sensor 52 senses a change in weather, the buzzer 53 is activated to emit a warning. The system may also notify users via wireless communication to evacuate or take appropriate measures, enhancing residential safety.

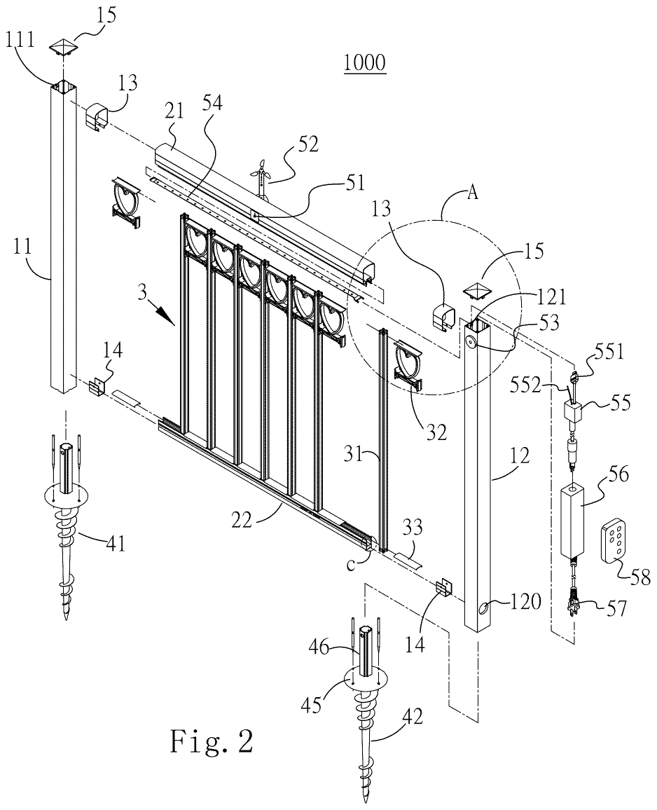

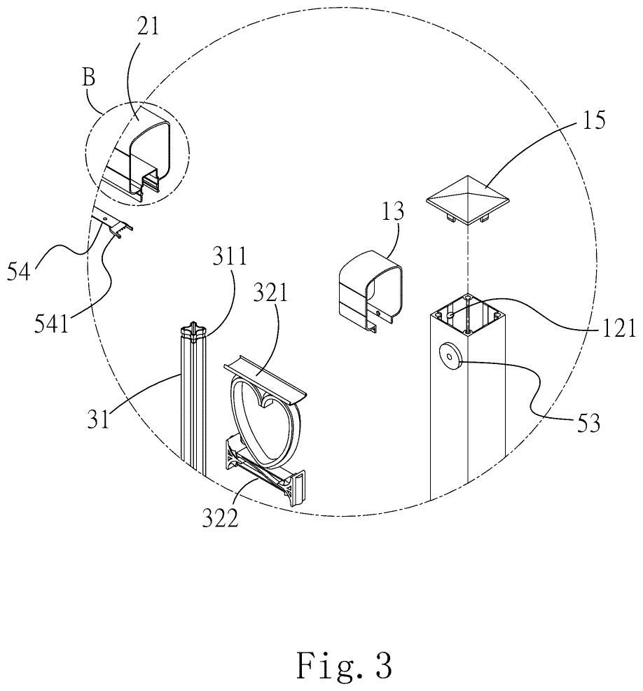

As shown in FIGS. 2 and 3, the upper ends of the side surfaces of posts 11 and 12 are coupled with the upper horizontal beam 21 via an upper beam fastener 13. The lower ends of the side surfaces are coupled with the lower horizontal beam 22 via a lower beam fastener 14. The tops of posts 11 and 12 are fitted with post caps 15, which may have conical, circular, or other shapes. Each post cap 15 has tenon strips at its bottom end to insert into posts 11 and 12.

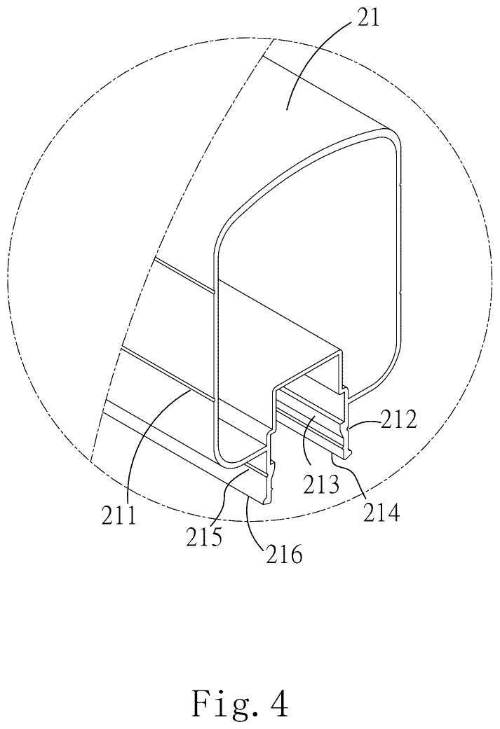

As shown in FIG. 4, the outer surface of the upper horizontal beam 21 has a locking groove 211, the lower end of the upper horizontal beam 21 is provided with a downward-opening locking portion 212, which includes a tenon strip 213 and a protrusion 214 inside, and a locking groove 215 and flange 216 on the outer side.

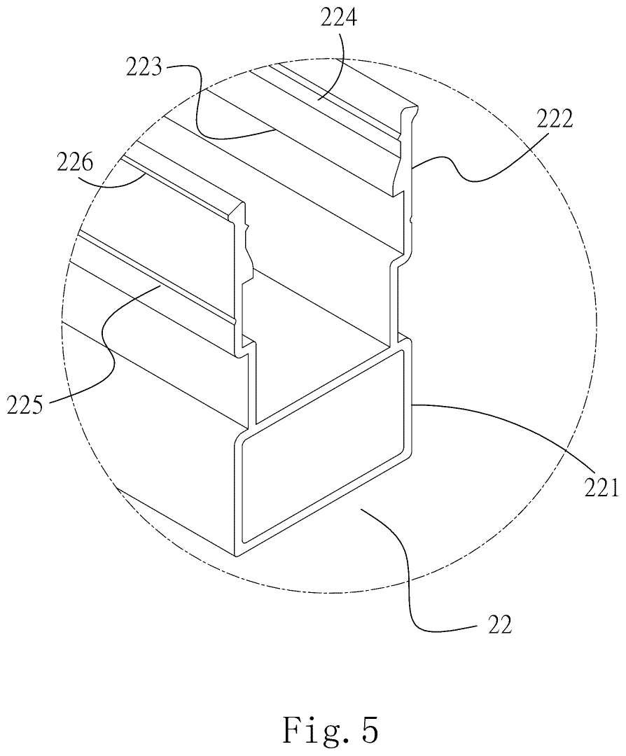

As shown in FIG. 5, the lower horizontal beam 22 includes a tubular base 221 with an upward-opening locking portion 222, which includes a tenon strip 223 and a protrusion 224 inside, and a locking groove 225 and flange 226 on the outer side.

As also shown in FIG. 2, an LED light strip 54 is installed within the locking portion 212 of the upper horizontal beam 21. The LED light strip 54 includes multiple light-emitting diodes facing downward toward the railing assembly 3 to enhance aesthetics and visibility. Each end of the LED light strip 54 has a plug-in terminal 541 that passes through wire holes 111, 121 in posts 11, 12 to connect with a controller 55 housed inside the post 12. A connecting member 551 and antenna 552 extend from the top of controller 55, wherein the antenna 552 may extend out of the post 12, and the connecting member 551 may be used to connect to the human detection sensor 51, weather sensor 52, buzzer 53, and LED light strip 54. Upon detection of input from the human detection sensor 51 and weather sensor 52, the controller 55 further triggers the buzzer 53 to emit sound and the LED light strip 54 to emit light. The bottom of the controller 55 connects to a rechargeable battery 56, which is linked to a plug 57 that extends through a predefined wire hole 120 in post 12 for connecting to mains electricity, thereby supplying power to human detection sensor 51, weather sensor 52, buzzer 53, and LED light strip 54.

The human detection sensor 51 is an infrared sensor that detects infrared radiation emitted by human bodies using the pyroelectric effect. A remote control 58 can wirelessly communicate with controller 55 via antenna 552 to adjust the settings of human detection sensor 51, weather sensor 52, buzzer 53 or LED light strip 54.

The railing assembly 3, located between the upper horizontal beam 21 and the lower horizontal beam 22, includes multiple spacing rods 31. The upper parts of each spacing rod 31 is separated by a decorative panel 32, and the lower parts of each spacing rods 31 is separated by a partition plate 33.

As shown in FIGS. 3 and 4, two annular grooves 311 are respectively formed on the upper end and lower end of the spacing rods 31. The upper annular groove 311 engages the tenon strip 213 of the upper horizontal beam 21's locking portion 212, while the lower annular groove (not shown) engages the tenon strip 223 of the lower horizontal beam 22's locking portion 222. The decorative panel 32 has a connecting plate 321 on its top end for insertion into the tenon strip 213 included in the locking portion 212 of the upper horizontal beam 21, and a lower divider 322 abuts the adjacent spacing rods 31.

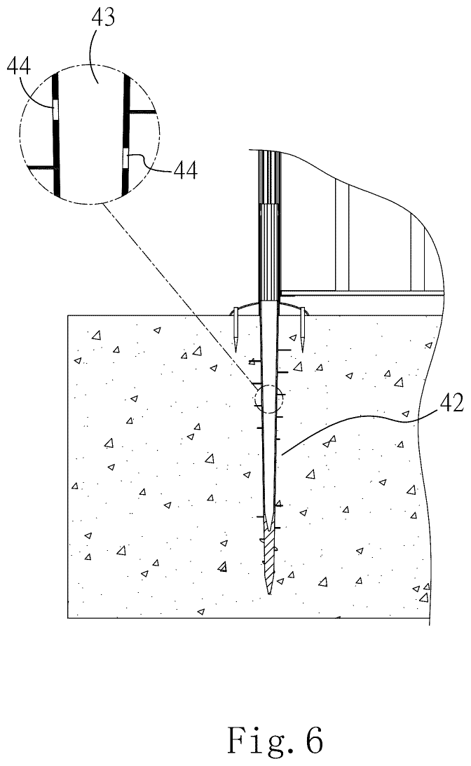

As shown in FIGS. 2 and 6, the outer surfaces of ground stakes 41 and 42 are threaded. Each stake defines an inner channel 43, the wall of which is provided with a plurality of holes 44 that communicate with the outside. After the stakes are driven into the ground, a soil hardening agent (either in powder or liquid form) is filled into the inner channel 43. Upon injection of water, the soil hardening agent mixes with the water and flows outward through the holes 44, permeating the surrounding soil. This enables the stakes 41 and 42 to form a firm bond with the surrounding soil, thereby providing a foundation structure with excellent anchoring strength. The upper ends of the ground stakes 41 and 42 are respectively provided with base plates 45, above which polygonal sleeves 46 extend upward. These polygonal sleeves 46 are configured to receive and secure the upright posts 11 and 12.

Accordingly, the assembled fence/railing structure 1000 can be securely anchored to the soil, and the upright posts 11 and 12, upper horizontal beam 21, lower horizontal beam 22, and railing assembly 3 can all be conveniently assembled and disassembled. Moreover, due to the inclusion of a human detection sensor 51 capable of detecting nearby persons, a weather sensor 52 for sensing ground-level wind speed and rainfall changes, a buzzer 53 capable of emitting an alarm sound, and an LED light strip 54 capable of illumination, the structure provides excellent safety protection for residents.

In addition, by providing a wireless communication module within the controller 55, when the human detection sensor 51 detects an unauthorized intrusion, or when the weather sensor 52 senses that the ground-level wind speed or rainfall has exceeded a preset value, a signal is automatically transmitted to the controller 55. In response, the controller 55 not only automatically activates the buzzer 53 to emit an alarm sound, but also sends a notification to the resident or a remote user via the wireless network.

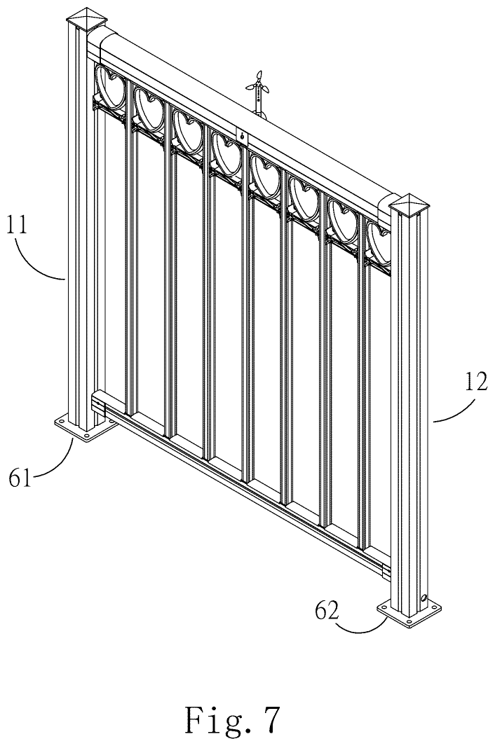

As shown in FIG. 7, a second embodiment of the improvement of fence/railing structure of the present invention is illustrated. In this embodiment, depending on local environmental conditions, ground stakes may be omitted. Instead, square base plates 61 and 62 are respectively disposed beneath the upright posts 11 and 12, and the square base plates 61 and 62 are fixed directly onto a non-soil foundation (e.g., a wooden deck).

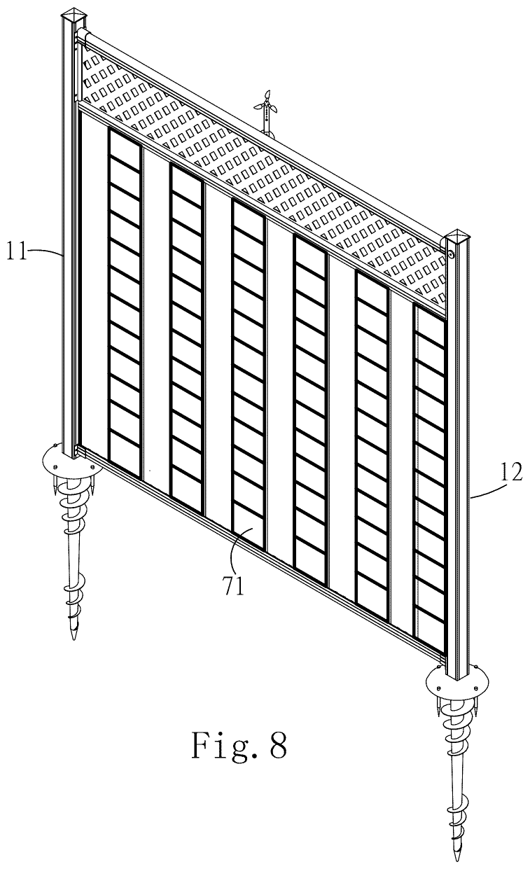

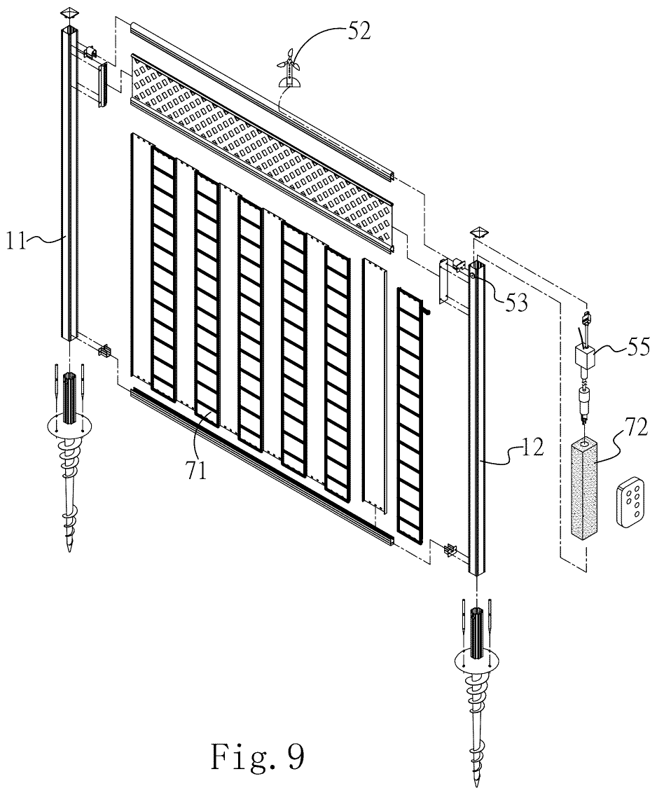

As shown in FIGS. 8 and 9, a third embodiment of the improvement of fence/railing structure of the present invention is illustrated. In this embodiment, the railing assembly may be replaced with a solar power generation panel 71 capable of generating electricity through solar irradiation. The electricity generated by the solar panel 71 may be stored in a solar battery 72, which supplies power to the controller 55 and provides the necessary electricity for components such as the weather sensor 52 and the buzzer 53. This configuration allows for greater flexibility in installation locations, particularly in remote areas or locations where utility power is not readily available.

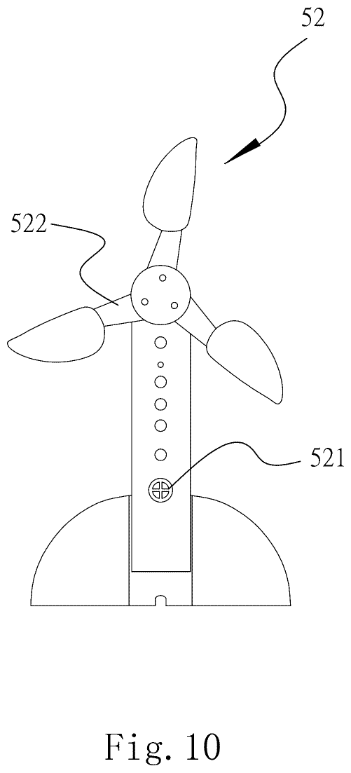

As shown in FIG. 10, the weather sensor 52 comprises a rainfall sensing unit 521 configured to detect rainfall, and a wind speed sensing unit 522 configured to detect wind speed. The rainfall sensing unit 521 internally includes a capacitive rain sensor (not shown). The sensing principle of the capacitive rain sensor is based on the change in capacitance between two parallel electrode plates inside the sensor. When rainwater falls onto the electrode plates, the dielectric between the plates changes, resulting in an increase in capacitance. By detecting the variation in capacitance and converting the data into an electronic signal, the signal processor can calculate and obtain rainfall information. This measured rainfall data is then compared with a preset rainfall threshold value. When the controller receives data indicating that the wind speed or rainfall has exceeded the preset threshold, the buzzer is activated to emit an alarm sound.

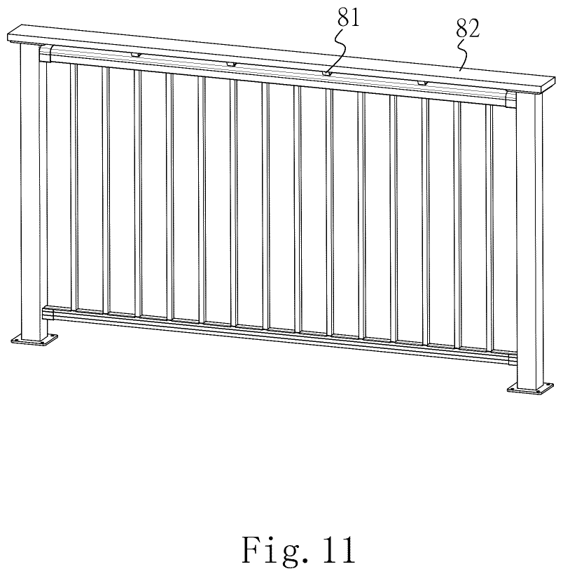

As shown in FIG. 11, a fourth embodiment of the improvement of fence/railing structure of the present invention is illustrated. In this embodiment, multiple connecting members 81 may be installed on the upper side of the upper horizontal beam. A drink rail panel 82 may then be mounted via the connecting members 81. The upper surface of the drink rail panel 82 provides a platform for placing beverage cups, bottles, or other objects.

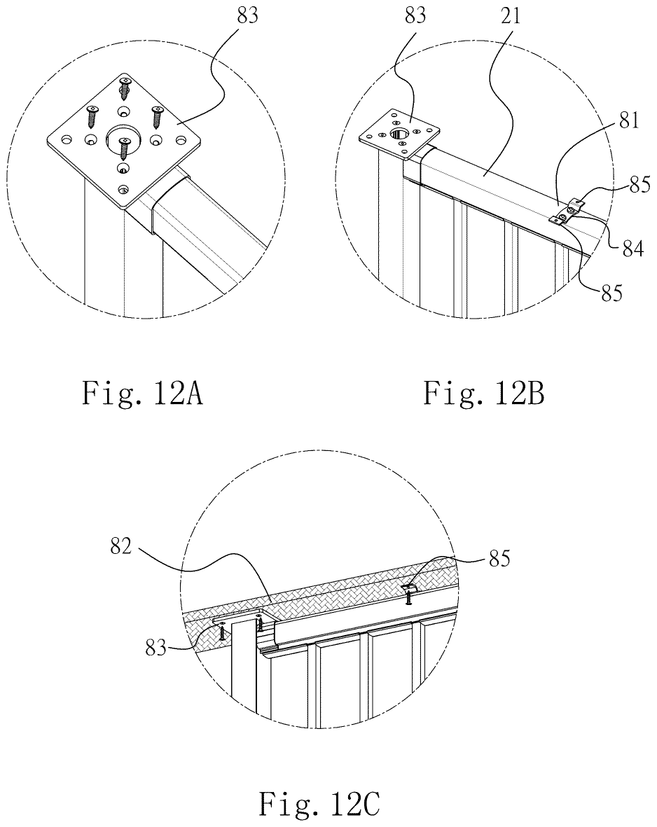

As shown in FIGS. 12A, 12B, and 12C, when installing the drink rail panel 82 on top of the upper horizontal beam, the post cap on the upright post is first removed and replaced with a mounting plate 83. Multiple connecting members 81 are then mounted on the upper side of the upper horizontal beam 21. Each connecting member 81 is fastened to the upper horizontal beam 21 via a base plate 84. Both sides of the base plate 84 are provided with upwardly raised and laterally extending connection plates 85. Accordingly, after the drink rail panel 82 is placed atop the connecting members 81, it is secured by fastening to the connection plates 85 of the respective connecting members 81.

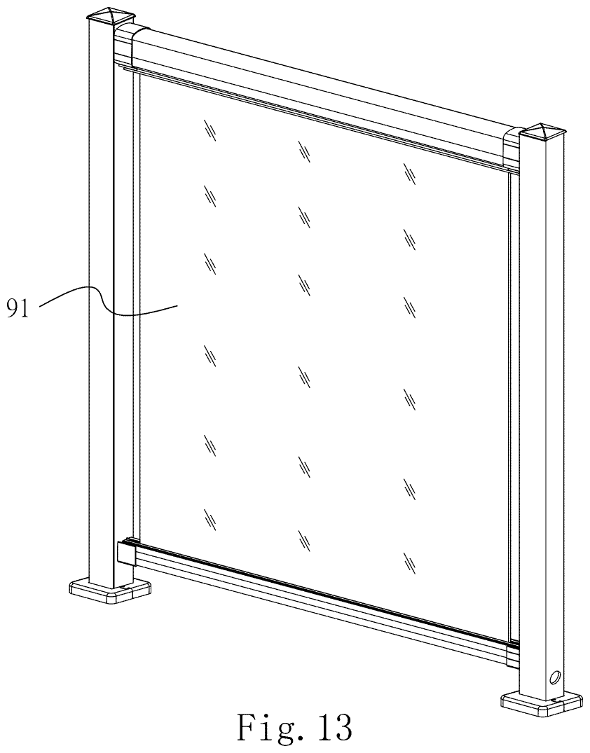

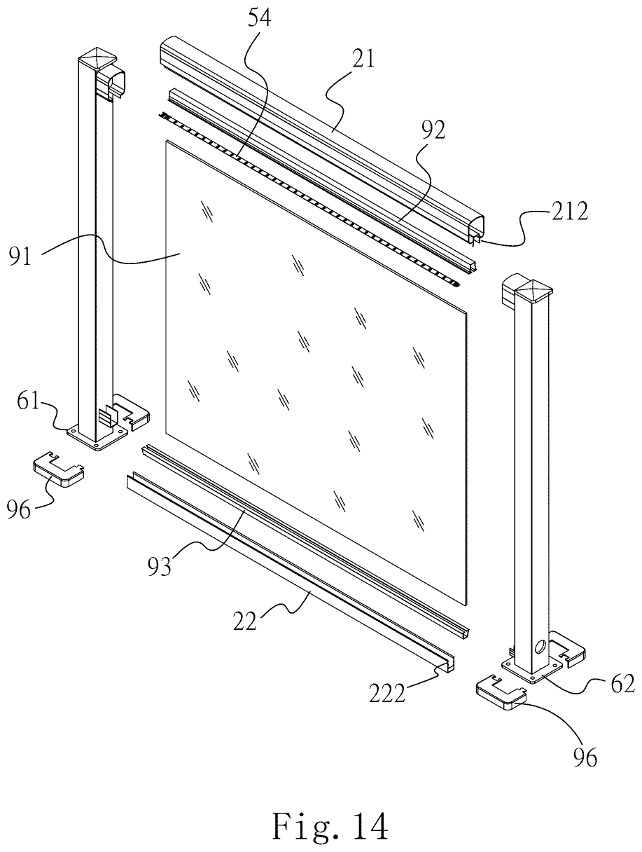

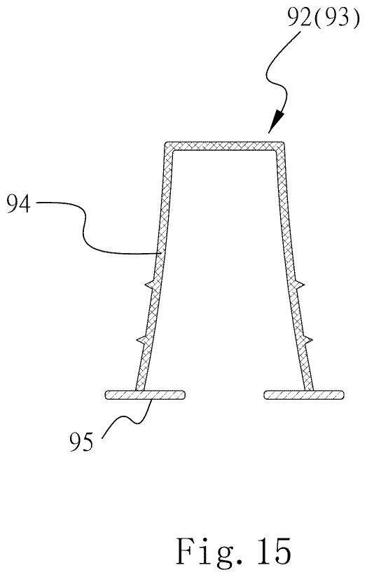

As shown in FIGS. 13, 14, and 15, a fifth embodiment of the improvement of fence/railing structure of the present invention is illustrated. In this embodiment, the railing assembly may be formed by a glass panel 91. The upper end of the glass panel 91 is clamped by an upper glass sleeve 92, the upper end of which is inserted into the locking portion 212 of the upper horizontal beam 21. The lower end of the glass panel 91 is clamped by a lower glass sleeve 93, the lower end of which is inserted into the locking portion 222 of the lower horizontal beam 22. An LED light strip 54 is disposed between the upper glass sleeve 92 and the glass panel 91. The head ends 94 of the upper and lower glass sleeves 92 and 93, which are inserted into the respective locking portions 212 and 222, are made of rigid polyvinyl chloride (PVC) material, while the clamping ends 95 that hold the glass panel 91 are made of soft polyvinyl chloride (PVC) material. The square base plates 61 and 62 disposed below the posts can be further secured to the ground after being fastened and protected by a locking element 96.

Thus, by inserting the head ends 94 made of rigid plastic material into the locking portions 212 and 222, and by clamping the glass panel 91 with the clamping ends 95 made of soft plastic material, rapid installation and secure fixing of the glass panel 91 can be achieved. Additionally, illumination from the LED light strip 54 enhances the aesthetic appearance and lighting effect of the glass panel 91.

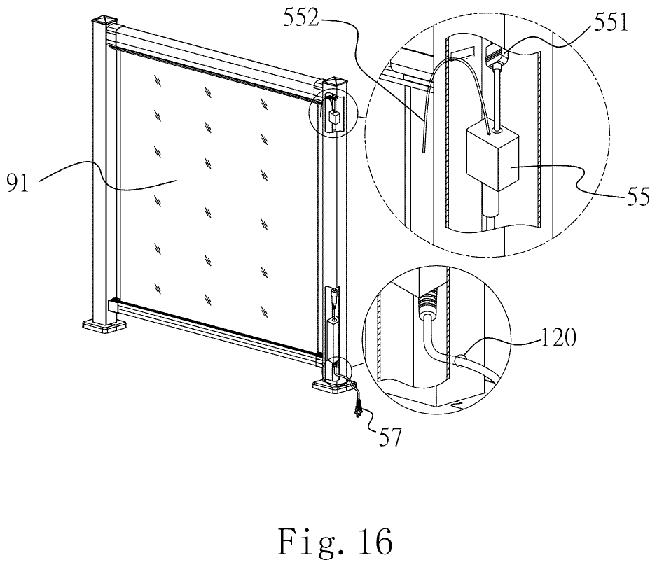

As shown in FIG. 16, the controller 55 disposed inside the post is connected to the human detection sensor, weather sensor, buzzer, and LED light strip via an upward-extending connector base 551. The antenna 552, when extended outward, allows for remote control operation via the remote controller 58. The plug 57 at the lower end of the storage battery passes through a predetermined wiring hole 120 and connects to the mains power supply. Accordingly, the design not only maintains a neat appearance but also provides enhanced illumination or warning effects for the glass panel 91.

The improvements of the fence/railing structure according to the present invention, based on the above configuration, may be summarized as having the following features:
1. By embedding energy-efficient LED light strips into the fence/railing structure, multiple lighting modes can be implemented. Through circuit layout and control system design, the lighting provides soft ambient illumination during normal use, enhancing visibility in the surrounding area. Under special circumstances, such as emergencies, the system can switch to a high-intensity flashing mode to alert nearby individuals.
2. By additionally installing a detachable drink rail panel on top of the railing, the structure not only provides a surface for placing items such as drink cups or water bottles, but also does so without compromising the overall protective functionality of the fence.
3. The fence/railing is equipped with solar panels capable of converting solar energy into electrical power, which is stored in a solar battery. Through an intelligent power management system, stable and continuous power is supplied to various electronic components on the fence, such as LED light strips, buzzers, human detection sensors, and weather sensors, achieving energy self-sufficiency and environmentally friendly operation. This reduces reliance on external power grids and is particularly suitable for remote areas or locations with limited power supply, thereby lowering both operational costs and energy consumption.
4. By integrating human detection technology, when abnormal activity such as an unauthorized person approaching or climbing over the fence is detected, the buzzer is immediately triggered to emit a high-decibel alarm, serving as a deterrent to potential intruders. At the same time, a communication module can be additionally installed in the controller to transmit the alarm information wirelessly to the user's mobile device or monitoring center, ensuring timely identification and response to potential security threats.
5. By installing weather sensors on the fence, external environmental parameters such as temperature, humidity, atmospheric pressure, and wind speed can be monitored in real time. When severe weather conditions such as heavy rain, strong winds, or snowstorms are detected, high-intensity warning lights on the fence are automatically activated to flash and alert nearby individuals to ensure their safety. Additionally, weather warning information can be transmitted to the mobile devices of relevant personnel, allowing them to take precautionary measures in advance and thereby safeguarding both people and property.

Glass panels can be installed on the fence using rubber channels, allowing compatibility with glass of varying thicknesses. Elastic cushioning pads may be added inside the channels to protect the glass and enhance sealing performance. The upper and lower rubber channels can be designed as concealed structures, resulting in a cleaner and more aesthetically pleasing appearance. Positioning markers or guiding elements may also be incorporated on the channels to facilitate accurate glass installation. Since the rubber channels are detachable, individual components can be replaced if the glass or channel is damaged, thereby reducing maintenance costs. Additionally, drainage or ventilation holes may be integrated into the channels to prevent water or gas accumulation that could compromise adhesion.

In addition to being manufactured from aluminum alloy, the main structure of the fence may also be made from advanced composite materials. For example, it can be constructed using high-strength fibers (such as carbon fiber or glass fiber) combined with high-performance resin matrices. This allows the overall building material to exhibit characteristics such as lightweight, high strength, corrosion resistance, and excellent weather durability. Compared to traditional metal railings, it significantly reduces transportation and installation costs, while also extending service life and reducing maintenance frequency. Even under harsh natural environments or chemically corrosive conditions, the fence can maintain good structural integrity and aesthetic stability, ensuring long-term and reliable protective functionality. Furthermore, during long-term outdoor use, it is less prone to rusting, deformation, or fading, effectively lowering maintenance costs and replacement frequency. Its excellent insulating properties also enhance safety in special environments, such as areas near electrical equipment.

In summary, the improvement of fence/railing structure of the present invention, by incorporating components such as a human detection sensor, weather sensor, and buzzer into the fence, can effectively enhance the safety of residents. The overall design clearly complies with the requirements of the Patent Law. Accordingly, this application is respectfully submitted for examination and grant of patent rights.

It should be noted that the foregoing descriptions merely illustrate the best specific embodiments of the present invention. However, the structural features of the present invention are not limited thereto. Any variations or modifications that are easily conceived by those skilled in the art within the scope of the present invention shall fall within the scope of the claims of this application.

What is claimed is:

1. An improvement of fence/railing structure, comprising:
two posts;
a set of horizontal beams including an upper horizontal beam and a lower horizontal beam, wherein both ends of the upper and lower horizontal beams are respectively connected to the two posts via an upper horizontal beam fastener and a lower horizontal beam fastener;
a railing assembly arranged between the upper and lower horizontal beams and located between the two posts;
wherein the fence/railing structure further includes a human detection sensor and a buzzer, wherein the human detection sensor is configured to sense/detect a human approaching; the buzzer is configured to emit an alarm sound; and a controller is connected to both the human detection sensor and the buzzer;
thereby, when the human body sensor senses/detects an intruder, the controller activates the buzzer to emit an alarm sound, thereby enhancing the security protection for residents.

2. The improvement of fence/railing structure as claimed in claim 1, further includes a weather sensor connected to the said controller, such that when a wind speed and/or rainfall exceed a preset thresholds, the said controller activates the buzzer to emit an alarm sound.

3. The improvement of fence/railing structure as claimed in claim 2, further includes a LED light strip connected to the said controller; the said controller controls the LED light strip to emit illumination, warning flashes, or other lighting patterns.

4. The improvement of fence/railing structure as claimed in claim 1, wherein the said controller is installed inside one of the posts, with an upper end extending a connecting member and an antenna, and lower end connected to a battery; the other end of the battery is connected to mains power via a plug; a communication module is installed inside the said controller to notify the user remotely.

5. The improvement of fence/railing structure as claimed in claim 1, wherein the lower end of the said upper horizontal beam includes a downward-opening locking portion, and the upper end of the said lower horizontal beam includes an upward-opening locking portion; the said upper and lower horizontal beams are locked to the said railing assembly via their respective locking portions; the said LED light strip is installed inside the locking portion of the upper horizontal beam to illuminate the said railing assembly.

6. The improvement of fence/railing structure as claimed in claim 5, wherein the above of the said upper horizontal beam install a detachable drink rail panel via multiple connecting members; the drink rail panel is configured to provide placement for drink cups or other objects.

7. The improvement of fence/railing structure as claimed in claim 5, wherein the lower end of each said post is fixed to the ground via a ground stake, the ground stake's outer surface is threaded, and its interior forms an internal channel; multiple holes are formed on both sides of the internal channel, which communicate with the outside environment.

8. The improvement of fence/railing structure as claimed in claim 5, wherein the lower end of the post is fixed to a non-soil foundation via a base plate.

9. The improvement of fence/railing structure as claimed in claim 1, wherein the said railing assembly includes multiple spacing rods; the upper part between every two spacing rods is separated by a decorative plate; the lower part between every two spacing rods is separated by a partition plate.

10. The improvement of fence/railing structure as claimed in claim 1, wherein the said railing assembly can be a set of solar panels capable of generating power from sunlight; the electricity generated by the solar panels is stored in a solar battery; the solar battery is connected to the said controller to supply power to the said human detection sensor, said weather sensor, said LED light strip, said buzzer, and other devices.

11. The improvement of fence/railing structure as claimed in claim 1, wherein the said human detection sensor is an infrared sensor utilizing the pyroelectric effect to detect infrared radiation emitted by a human body, sensing whether the human body is moving or approaching; both the said human detection sensor and the said weather sensor are installed on the upper horizontal beam.

12. The improvement of fence/railing structure as claimed in claim 1, wherein the said railing assembly can be a set of glass panels; the upper end of the glass panel is clamped by an upper glass sleeve and the lower end of the glass panel is clamped by a lower glass sleeve; the said LED light strip is arranged between the upper glass sleeve and the glass panel.

13. The improvement of fence/railing structure as claimed in claim 12, wherein the said upper glass sleeve and lower glass sleeve respectively have a head end configured to be embedded into the locking portions of the said upper and lower horizontal beams, and a clamping end configured to clamp the said glass panel; the head end is made of rigid polyvinyl chloride (PVC) material, and the clamping end is made of soft PVC material.
